(19) United States
(12) Patent Application Publication
(10) Pub. No.: US 2003/0088470 A1
(43) Pub. Date: May 8, 2003

(54) System and process for debit card dispensing

(76) Inventor: Vincent Cuervo, Coral Gables, FL (US)

Correspondence Address: GREER, BURNS & CRAIN, 300 S WACKER DR, 25TH FLOOR, CHICAGO, IL, 60606, US

(21) Appl. No.: 10/342,991

(22) Filed: Jan. 15, 2003

Related U.S. Application Data
(63) Continuation of application No. 10/114,522, filed on Apr. 2, 2002.
Application No. 10/114,522 is a continuation-in-part of application No. 09/894,581, filed on Jun. 28, 2001.
Application No. 09/894,581 is a continuation-in-part of application No. 09/524,496, filed on Mar. 13, 2000, now Pat. No. 6,405,182.
Application No. 09/524,496 is a continuation-in-part of application No. 09/207,854, filed on Dec. 8, 1998.
Application No. 09/207,854 is a continuation-in-part of application No. 09/128,088, filed on Aug. 3, 1998, now Pat. No. 6,105,009.
Application No. 09/128,088 is a continuation-in-part of application No. 08/877,006, filed on Jun. 16, 1997, now abandoned.

(51) Int. Cl. G06F 17/60

(52) U.S. Cl. 705/16; 705/17; 705/41

(57) ABSTRACT

Systems and processes allow for dispensing pre-paid debit cards and the like from point of sale locations such as merchants. Pre-paid debit cards may be obtained in desired amounts. Communication from the point of sale location with a remote facility allows for subsequent use of the debit card from other locations.

### CROSS REFERENCE

The present application is a continuation of co-pending U.S. application Ser. No. 10/114,522 filed on Apr. 2, 2002; which is a continuation in part of U.S. application Ser. No. 09/894,581 filed on Jun. 28, 2001; which is a continuation in part of U.S. application Ser. No. 09/524,496 filed on Mar. 13, 2000 (and now U.S. Pat. No. 6,405,182), which is a continuation in part of application Ser. No. 09/207,854 filed Dec. 8, 1998; which is a continuation in part of application Ser. No. 09/128,088 filed Aug. 3, 1998 (and now U.S. Pat. No. 6,105,009); which is a continuation in part of U.S. application Ser. No. 08/877,006 filed on Jun. 6, 1997 and now abandoned. These applications are incorporated herein by reference.

### BACKGROUND OF THE INVENTION

The present invention relates to systems and processes for dispensing debit cards and the like.

The prior art includes processes and systems for dispensing debit cards, with an example including telephone debit cards. These known processes and systems, however, are generally complicated, costly and otherwise cumbersome. Additionally, they often do not provide acceptable levels of security and flexibility.

Accordingly, a number of needs are unresolved in the art.

### SUMMARY OF THE INVENTION

One embodiment of the present invention is a process for dispensing debit cards comprising the steps of receiving user particulars data and transaction particulars data with a first computer, storing the user and transaction particulars data in a first computer memory, and receiving funds. The exemplary process further includes steps of computing a line of credit, and using the first computer to validate the funds and to generate a validation signal. The line of credit is stored in the first computer memory. A debit card having a unique identifier is dispensed only after the validation signal is communicated from the first computer, and the unique identifier communicated back to the first computer.

### BRIEF DESCRIPTION OF THE DRAWINGS

FIG. 1 is a schematic useful for describing an exemplary embodiment of the present invention.

FIG. 2 is a flow chart summarizing the process steps of an exemplary process of the invention.

### DETAILED DESCRIPTION OF THE PREFERRED EMBODIMENTS

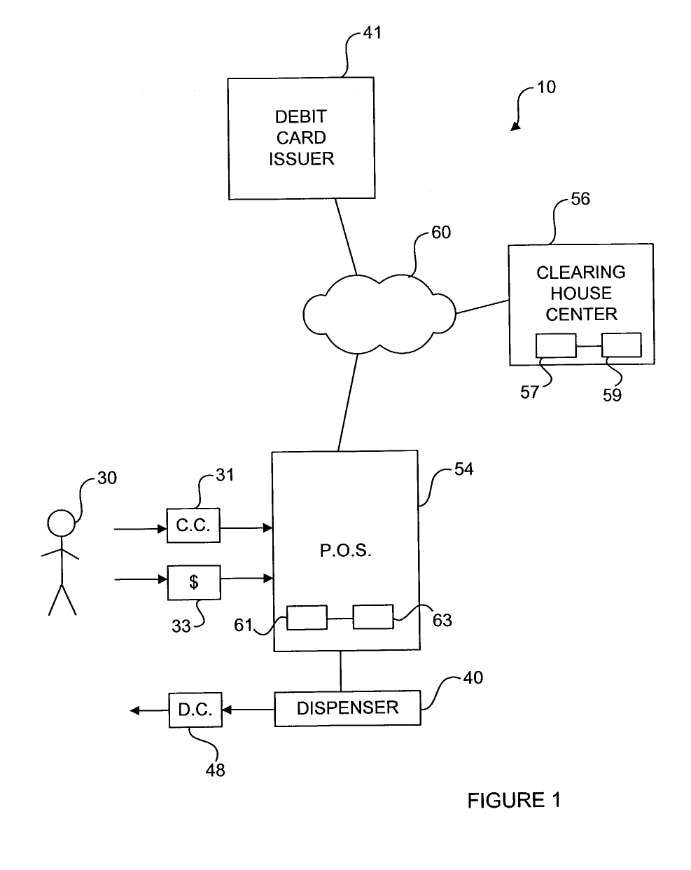

Referring now to the drawings, a system embodiment of the present invention is generally referred to with numeral 10 in FIG. 1. It will be appreciated that the present invention includes processes as well as systems, and that in the description of a system of the invention such as 10 a description of a process may likewise be presented. For example, it will be appreciated that the system 10 of the invention may carry out a process of the invention.

The system 10 includes a point of sales terminal (“POS”) 54 that may be an ATM or the like, and may have input and output hardware such as a bill acceptance port, a credit/debit card charge assembly, a keypad, and the like. POS terminals 54 are generally widely available in retail outlets. It will be appreciated that a merchant using a register or the like may also function as the POS 54. A purchaser 30 has a credit card 31 and/or currency 33. A dispenser is shown at 40 and a card issuer at 41. The card issuer 41 may be the issuer of the debit card 48 and/or the credit card 31. The dispenser 40 may be a merchant such as a clerk or cashier, an entity or place selling the card, an automated machine, or the like. It may be a part of the POS 54 or may be separate therefrom. The dispenser 40 can have three or more stacks of debit cards 48 that each has a unique identifier such as a digital storage number or the like. A clearinghouse 56 is connected to a telecommunications network 60, which is also connected to the card issuer 41 and the POS 54. The clearinghouse 56 has a computer 57 with an associated storage or memory 59. The POS 54 also has a computer 61 with an associated storage assembly or memory 63.

As shown in FIG. 1, a card purchaser 30 initiates a process of the invention when approaching a merchant offering the sale of prepaid debit cards through a POS 54. Once the purchaser 30 determines a prepaid amount to be purchased and credited to the debit card 48, the user's particulars are entered to the computer 61. The particulars may include, for instance, one or more of his name, address, social security number, a personal identification number (“PIN”) and the like. The particulars may be obviated under certain circumstances (e.g., use of a bearer debit card). The issuer 41 determines the amount of particulars required, and may consider issuers of flexibility for the purchaser in terms of how much information he wants to disclose. Generally, the more information that is disclosed, the more secure the debit card 48 will be. Optionally, a second PIN number may be used for additional security. The information entered by the debit card purchaser 30 is stored in storage assembly 63 by the computer assembly 61 for consequent transmission to clearinghouse 56.

A line of credit is computed and stored in the storage means 63. The computer 61 generates a validation signal, which is communicated from the POS terminal 54 to the dispenser 40. After receiving the validation signal, the dispenser 40 may dispense the debit card 48. The unique identifier for the debit card 48 is communicated to the computer 61. If the user 30 has requested, a plurality of debit cards 48 may be dispensed, and the unique identifier for each of the plurality communicated to the computer 61. The computer 61 assembles a block of information for transmission, including the user particulars data, the transaction particulars data, and the debit card 48 unique identifier(s), and the like. This block of information may be then communicated over the communications network 60 to the clearinghouse 56, where it is received and processed by the second computer 57 and stored on the storage 59 along with the line of credit.

The following example will be helpful in further illustrating the invention. For a cash transaction, a merchant may collect the cash 33 from the user 30 as if it were for purchase of merchandise, services, or a similar routine transaction. The merchant will enter the debit card 48 unique identifier, such as an issuing bank's ID number, to the computer 61 for a “virgin” (i.e., not validated) debit card 48 for the amount of money 33 prepaid. Once this data has been entered to the computer 61, it is stored on the storage 63, and a line of credit is calculated. A validation signal is generated, and the merchant dispenses the debit card 48. The merchant may also charge a small processing fee.

If more than one card 48 is dispensed to the same purchaser 30, then the unique identifiers such as serial numbers for each card 48 will be linked to each other, with the result that all of the plurality of cards 48 are associated with the same line of credit. This may be desirable, for instance, so that the card purchaser 48 can obtain a plurality of cards 48 and distribute them to others, with examples including a traveling salesman, a child in college or other family member away from home, who will then be able to use the debit card 48 within the available line of credit. The card purchaser 30 can then reload the debit card for the others' remote usage, thus effectively constituting an instantaneous transfer of funds.

In another aspect of the present invention, a card issuer 41 may offer incentives to the purchaser 30 to encourage or to discourage use of the debit card 48. For example, a card issuer 41 may offer incentives to a user to use the debit card 48 in a specified geographic area. By way of additional example, a card issuer 41 may offer to provide interest payments on a deposited line of credit, or may provide an incentive to use a line of credit after determining that it has been unused for a period of time.

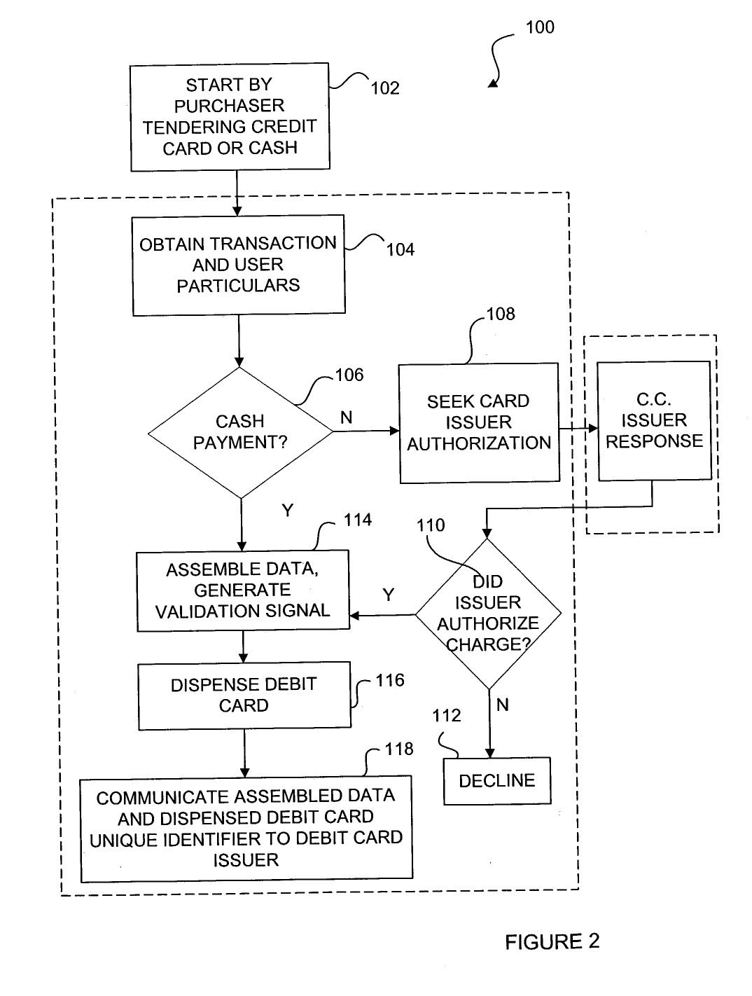

FIG. 2 is a flowchart illustrating steps of an additional exemplary invention embodiment 100. It will be appreciated that the steps of the process 100 may be carried out using the system 10 of FIG. 1, or another system. The process 100 begins when a purchaser begins a transaction by tendering cash or a credit card (block 102). User particulars are then obtained (block 104). Obtaining user particulars may include, for instance, oral communication with the customer, entry by the customer of data into a POS. terminal 54 or the like, or through communication with a credit card issuer after obtaining a credit card. A determination is made whether cash or a credit card has been tendered (block 106). If a credit card, the computer communicates with a card issuer to obtain authorization (block 108). If the issuer doesn't authorize the charge, the computer declines the transaction (blocks 110 and 112).

If the tendered funds were cash or if the credit card issuer granted authorization, data is assembled and a validation signal generated (block 114). The assembled data may include, but is not limited to, user and transaction particulars. Finally, a debit card is dispensed (block 116). The assembled data and the unique identifier for the dispensed debit card are communicated to the debit card issuer (block 118).

Those skilled in the art will appreciate that the exemplary aspects of invention embodiments discussed herein are for illustration purposes only, and that the invention is not limited to these exemplary aspects.

What is claimed is:

1. A process for dispensing debit cards comprising the steps of:
receiving user particulars data and transaction particulars data with a first computer, said first computer having a memory;
storing said user particulars data and said transaction particulars data in said first computer memory;
receiving funds;
validating said funds with said first computer;
computing a line of credit and storing said line of credit in said first computer memory;
generating a validation signal with said first computer;
dispensing at least one debit card only after said validation signal is communicated from said first computer, said debit card having a unique identifier; and
communicating said debit card unique identifier to said first computer.

2. A process for dispensing a debit card as defined by claim 1, wherein said first computer is linked to a communications network, and wherein the method further comprises the steps of:
assembling a block of information with said first computer, said block of information including at least said user particulars data, said transaction particulars data, and said debit card unique identifier, and
communicating said block of information to a second computer over said communications network, said second computer having a memory, and storing said block of information in said second computer memory.

3. A process as defined by claim 2 wherein said block of information includes said line of credit.

4. A process as defined by claim 1 wherein said first computer is contained in a point of sale terminal having a bill acceptance port, a credit/debit card charge assembly, and a debit card dispenser.

5. A process as defined by claim 1 wherein the step of dispensing the debit card comprises dispensing the debit card with a dispenser, said dispenser having a plurality of said debit cards and being separate from said first computer.

6. A process as defined by claim 1 wherein the step of dispensing the debit card comprises a merchant dispensing the debit card.

7. A process as defined by claim 1 wherein said first computer is connected to a communications network, wherein the step of receiving user particulars data comprises obtaining data from a user credit card and communicating with a card issuer over said communications network to obtain user particulars data, wherein the step of receiving funds comprises communicating with the card issuer over said communications network to obtain issuer authorization and to charge the credit card.

8. A process as defined by claim 1 wherein said first computer is connected to a communications network, wherein the step of receiving funds comprises obtaining information from a credit card and a requested amount of funds, and wherein the method further includes the step of communicating with a credit card issuer over said communications network to obtain authorization.

9. A process as defined by claim 1 and further including the step of associating a plurality of unique card identifiers from a plurality of said debit cards with a single line of credit, and dispensing said plurality of debit cards, whereby a plurality of users may access said line of credit.

10. A process as defined by claim 1 and further including the step of a card issuer providing at least one incentive for a debit card user.

11. A process as defined by claim 1 wherein said user particulars data include at least a first and a second personal identification number.

12. A process for dispensing debit cards comprising the steps of:
obtaining data from a user credit card with a first computer;
obtaining transaction particulars data with said first computer;
using said first computer to communicate with a credit card issuer over said communications network to obtain user particulars data and to obtain authorization;
storing said user particulars data and said transaction particulars data in a first computer memory;
computing a line of credit and storing said line of credit in said first computer memory;
generating a validation signal with said first computer;
dispensing at least one debit card only after said validation signal is communicated from said first computer, said debit card having a unique identifier; and
communicating said debit card unique identifier to said first computer.

13. A process for dispensing a debit card as defined by claim 12 wherein the step of dispensing a debit card comprises dispensing a plurality of debit cards, each of said plurality of debit cards having a unique identifier, wherein the step of communicating said debit card unique identifier to said first computer comprises communicating each of said unique identifiers to said first computer, and wherein said line of credit is associated with each of said unique identifiers.

14. A process for dispensing debit cards comprising the steps of:
receiving user particulars data and transaction particulars data with a first computer, said first computer having a memory and a data input for inputting said user data;
storing said user particulars data and said transaction particulars data in said first computer memory;
receiving funds and using said first computer to validate said funds;
computing a line of credit and storing said line of credit in said first computer memory;
generating a validation signal with said first computer;
dispensing a debit card with a dispenser only after said validation signal is communicated from said first computer, said debit card having a unique identifier;
communicating said debit card unique identifier to said first computer;
assembling a block of information with said first computer, said block of information including at least said user particulars data, said transaction particulars data, and said debit card unique identifier;
communicating said block of information to a second computer over a communications network, said second computer having a memory; and
storing said block of information in said second computer memory.

15. A process as defined by claim 14 wherein said first computer is contained in a point of sale terminal having a bill acceptance port and a credit/debit card charge assembly.

16. A process as defined by claim 14 wherein said dispenser is separate from said first computer and has a plurality of stacks of said debit cards.

17. A process as defined by claim 14 wherein said dispenser comprises a merchant.

18. A process as defined by claim 14 wherein the step of receiving funds is performed by a merchant, and the wherein the step of using said first computer to validate said funds comprises said merchant entering an amount of said funds into said first computer.

19. A process as defined by claim 14 and further including the step of a card issuer providing at least one incentive for a debit card user, said at least one incentive determined using said second computer.

20. A process as defined by claim 19 wherein said at least one incentive is chosen from the group of incentives consisting of: an incentive associated with use of said debit card in a specific geographical region, an incentive for encouraging use of the debit card and is applied after determining that the card has been unused for a period of time, and payment of interest on said line of credit.

21. A process as defined by claim 14 wherein the method comprises the step of communicating with a clearinghouse and with a card issuer over said communications network.
